(19) United States
(12) Patent Application Publication
(10) Pub. No.: US 2017/0177208 A1
(43) Pub. Date: Jun. 22, 2017

(54) SYSTEMS AND WEARABLE DEVICES AND METHODS FOR OPERATING A COMPUTER

(71) Applicant: Huizhou TCL Mobile Communication Co., Ltd., Huizhou City, Guangdong Province (CN)

(72) Inventor: YAGE YOU, Huizhou City, Guangdong Province (CN)

(21) Appl. No.: 15/301,367

(22) PCT Filed: Apr. 12, 2016
(86) PCT No.: PCT/CN2016/079048

§ 371 Date: Sep. 30, 2016

(30) Foreign Application Priority Data
Jul. 22, 2015 (CN) 201510439811.6

(51) Int. Cl. G06F 3/0488; G06F 1/16

(52) U.S. Cl. CPC G06F 3/04883; G06F 1/163; G06F 3/04886; G06F 3/04845

(57) ABSTRACT

Systems, wearable devices, and methods for operating a computer are disclosed. A wearable device includes a touch screen, a first processing module, and a first communication module, where the touch screen and the first communication module are coupled to the first processing module respectively. The wearable device enters a control mode, and the touch screen displays a control interface. When the user performs an operation on the control interface, the touch screen obtains a corresponding operation track. The first processing module converts the operation track to a corresponding operating instruction and transmits the operating instruction to the computer through the first communication module. The computer parses the operating instruction and performs a corresponding operation according to the parsed operating instruction. Thus, the wearable device can be used to manipulate the computer, increasing the user experience.

### TECHNICAL FIELD

The present disclosure generally relates to wearable devices, and in particular relates to systems, wearable devices, and methods for operating a computer.

### BACKGROUND

Smart wearable devices have now gained increasing popularity. Users can acquire their daily exercise and sleep quality through wearable devices, and can also use wearable devices to interact with the phones.

Yet when using a computer, users may need to use a mouse and keyboard to manipulate the computer. For example, when watching a movie on the computer, one may need to manipulate the mouse or keyboard for control of functions such as volume, fast forward, rewind, screenshots, etc., which may degrade the user experience.

### SUMMARY

Embodiments of the present disclosure provide systems, wearable devices, and methods for operating a computer, so that the computer can be manipulated through the wearable device, increasing the user experience.

A wearable device for operating a computer is disclosed, the wearable device comprising a processor, a memory storage, a transmitter, a bus, and a touch screen. The processor, memory storage, transmitter, and touch screen may be coupled to the bus respectively. The wearable device may enter a control mode, and the touch screen may display a control interface, so when a user performs an operation on the control interface, the touch screen may capture a corresponding operation track by way of a matrix, according to which the touch screen may pre-establish a coordinate system and obtain moving coordinates of the operation along a horizontal and a vertical axis of the coordinate system respectively to generate a matrix. The memory storage may be configured to store a program, and the processor may be configured to execute the program, the program being configured to convert the operation track to an operating instruction. The transmitter may be configured to transmit the operating instruction to the computer, which may parse the operating instruction and perform a corresponding operation according to the parsed operating instruction. The operation track may comprise a single-finger slide, single-finger click, single-finger double-click, single-finger click and hold, and double finger slide.

The operating instruction corresponding to the operation track may comprise a mouse movement, mouse left button click to select, mouse left button double-click to select, mouse right button click to select, and zooming of a display window on the display screen.

When the wearable device switches to an input mode, the user can enter text on the touch screen, the transmitter may transmit the text to the computer, and the computer may display the text in a text box.

A wearable device for operating a computer is further disclosed, the wearable device comprising a touch screen, a first processing module, and a first communication module, where the touch screen and the first communication module are coupled to the first processing module respectively. The wearable device may enter a control mode, and the touch screen may display a control interface. So, when a user performs an operation on the control interface, the touch screen may obtain a corresponding operation track. The first processing module may convert the operation track to an operating instruction and transmit through the first communication module the operating instruction to the computer. And the computer may parse the operating instruction and perform a corresponding operation according to the parsed operating instruction.

The touch screen may obtain the operation track by way of a matrix.

The touch screen may pre-establish a coordinate system and obtain moving coordinates of the operation along a horizontal and a vertical axis of the coordinate system respectively to generate a matrix.

The operation track may comprise a single-finger slide, single-finger click, single-finger double-click, single-finger click and hold, and double finger slide.

The operating instruction corresponding to the operation track may comprise a mouse movement, mouse left button click to select, mouse left button double-click to select, mouse right button click to select, and zooming of a display window on the display screen.

A method for operating a computer with a wearable device is further disclosed, comprising:

switching, by the wearable device, to a control mode;

acquiring, by the wearable device, an operation track of an operation a user performs on a control interface; and

converting, by the wearable device, the operation track to an operating instruction and transmitting the operating instruction to the computer to make the computer perform a corresponding operation according to the operating instruction.

Acquiring by the wearable device the operation track of the operation the user performs on the control interface may comprise obtaining by the wearable device the operation track by way of a matrix.

The operation track may comprise a single-finger slide, single-finger click, single-finger double-click, single-finger click and hold, and double finger slide.

The operating instruction corresponding to the operation track may comprise a mouse movement, mouse left button click to select, mouse left button double-click to select, mouse right button click to select, and zooming of a display window on the display screen.

By the above solutions, advantages of the present disclosure may follow. The wearable device may enter a control mode, and the touch screen may display a control interface accordingly, so when a user operates the control interface, the touch screen can acquire a corresponding operation track. The first processing module may then convert the operation track to an operating instruction and transmit the operating instruction to the computer through the first communication module. The computer may parse the operating instruction and thus perform a corresponding operation according to the parsed operating instruction. Thereby, the computer would be able to be manipulated with the wearable device, increasing the user experience.

### BRIEF DESCRIPTION OF THE DRAWINGS

FIG. 1 is a block diagram of a first embodiment of a system for operating a computer according the disclosure.

FIG. 2 illustrates a control interface in the first embodiment as illustrated in FIG. 1.

FIG. 3 illustrates a coordinate system in the first embodiment as illustrated in FIG. 1.

FIG. 4 is a flowchart illustrating a first embodiment of a method for operating a computer using a wearable device according to the disclosure.

### DETAILED DESCRIPTION

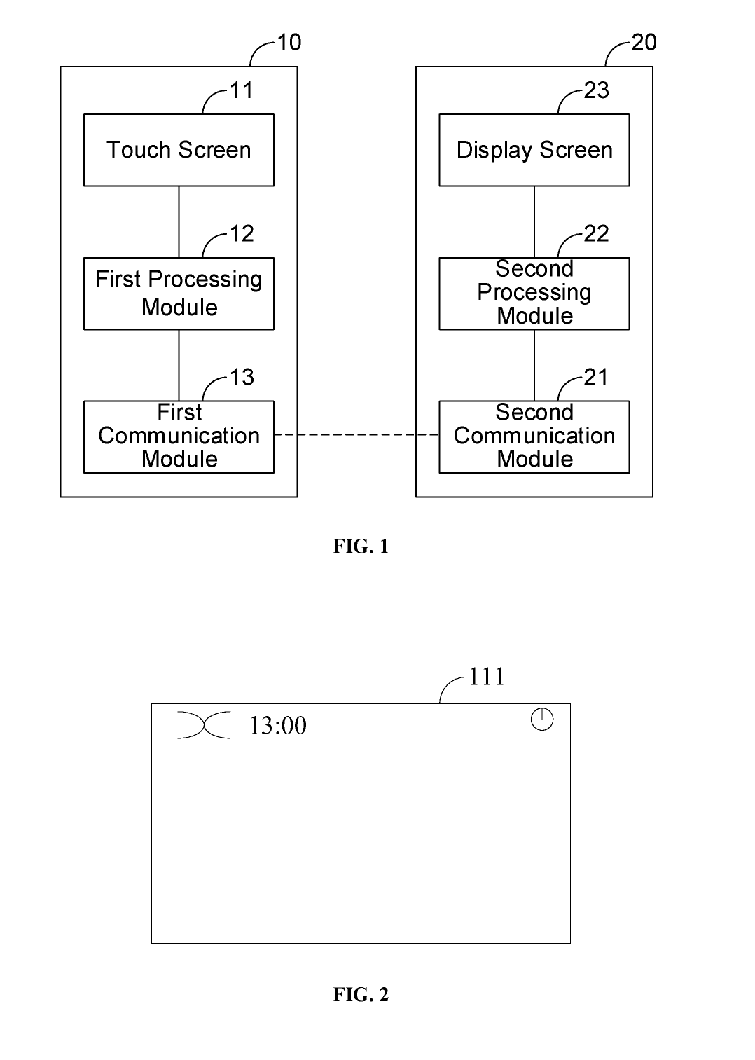

Referring to FIG. 1, in which a block diagram of a first embodiment of a system for operating a computer according to the disclosure is depicted. In the system the computer can be manipulated through operating the wearable device, thus eliminating the need of a mouse or keyboard to operate the computer. The system may comprise a wearable device 10 and a computer 20. The wearable device 10 may comprise a touch screen 11, a first processing module 12, and a first communication module 13, where the touch screen 11 and the first communication module 13 may both be coupled to the first processing module 12 respectively.

The touch screen 11 may be configured to display a variety of application icons, such as a phone call icon, message icon, and a computer remote control icon. The user can touch the touch screen 11 to open a corresponding application. Typically, an application may beforehand be installed on the wearable device 10, and the user can activate the pre-installed application to manipulate the computer 20.

If the user desires to manipulate the computer 20 with the wearable device 10, he may click the computer remote control icon, and the wearable device 10 may then enter a control mode and the touch screen 11 may display a corresponding control interface 111, an example of which is shown in FIG. 2. In the upper left corner of the control interface 111 may be displayed the connection status and duration between the wearable device 10 and the computer 20, while a Close button may be put on the upper right corner of the control interface 111.

When the wearable device 10 enters the control mode, it may establish a wireless connection with the computer 20 through the first communication module 13. So, when the user operates on the control interface 111, the touch screen 11 may obtain a corresponding operation track, and transfer the operation track to the first processing module 12. The first processing module 12 may convert the operation track to a corresponding operating instruction and transmit it to the computer 20 through the first communication module 13. And the computer 20 may parse the operating instruction and thus perform a corresponding operation according to the parsed operating instruction.

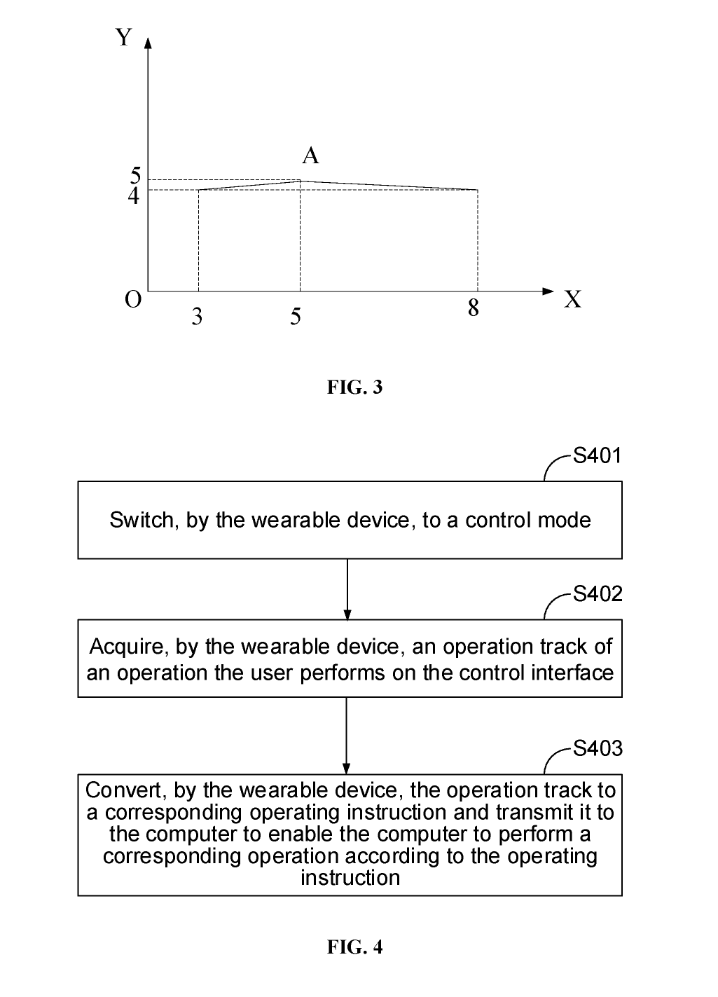

The touch screen 11 may obtain the operation track by way of a matrix. In particular, the touch screen 11 may first establish a coordinate system X-O-Y, as is shown in FIG. 3. In the figure A denotes the operation the user performs on the control interface 111. The touch screen 11 may acquire the moving coordinates of operation A along a horizontal axis (i.e., X axis) and a vertical axis (i.e., Y axis) respectively, so as to generate a matrix. For example, assume the moving coordinates of operation A along the horizontal axis are 3, 5, 8, while the corresponding moving coordinates along the vertical axis are 4, 5, 4, then we obtain a matrix

$$[ \begin{matrix}3 & 5 & 8 \\ 4 & 5 & 4\end{matrix} ] .$$

According to the matrix, the touch screen 11 may obtain the operation track of operation A as a single-finger slide.

The computer 20 may comprise a second communication module 21, a second processing module 22, and a display screen 23, where both the second communication module 21 and the display screen 23 may be coupled to the second processing module 22 respectively. The wearable device 10 may build up a wireless connection with the computer 20 through the first communication module 13, namely the wireless connection may be established between the first communication module 13 and the second communication module 21. Typically, the first communication module 13 and the second communication module 21 may be Bluetooth modules. Alternatively, the first communication module 13 and the second communication module 21 may be WiFi modules.

The second communication module 21 may fetch the operating instruction from the first communication module 13 and transfer the operating instruction to the second processing module 22. The second processing module 22 may be configured to parse the operating instruction, perform a corresponding operation according to the parsed operating instruction, and display the corresponding operation on the display screen 23.

The operation track may comprise a single-finger slide, single-finger click, single-finger double-click, single-finger click and hold, double finger slide, and so on. The operating instruction corresponding to the operation track may comprise a mouse movement, mouse left button click to select, mouse left button double-click to select, mouse right button click to select, zooming of the display window on the display screen 23, and so on.

Hereinbelow the process through which the user manipulating the computer 20 with the wearable device 10 will be described in greater detail.

The user may activate the control mode of the wearable device 10, and perform a slide operation on the touch screen 11. The touch screen 11 may then obtain the corresponding operation track of the slide operation as a single-finger slide. The first processing module 12 may convert the single-finger slide to an operating instruction of manipulating a mouse, and classify the operating instruction to a corresponding profile (e.g., mouse movement, mouse click, or screen shots). The first communication module 13 may then transmit the profile to the computer 20 using a specific transport protocol.

The computer 20 may acquire the profile through the second communication module 21. The second processing module 22 may then obtain the operating instruction from the profile and parse the operating instruction as a mouse movement. Thus, the second processing module 22 may control the cursor shown on the display screen 23 to move according to the operating instruction.

When the cursor has moved to the application intended to be activated, the user can perform a double-click operation on the touch screen 11, so the touch screen 11 may obtain the corresponding operation track of the double-click operation as a single-finger double-click. The first processing module 12 may convert the single-finger double-click to an operating instruction indicating mouse left button double-click to select. At this point, the computer 20 may select and activate the application according to the operating instruction.

If the application activated is a text box, the user may switch the wearable device 10 to an input mode, in which the user can enter text on the touch screen 11, and the computer 20 may display the text input by the user in the text box, further the text can be edited.

Note the wearable device 10 as disclosed in the present embodiment may typically be a smart watch or smart bracelet.

As such, the touch screen 11 may obtain a corresponding operation track, and transfer the operation track to the first processing module 12. The first processing module 12 may convert the operation track to a corresponding operating instruction and transmit it to the computer 20 through the first communication module 13. And the computer 20 may parse the operating instruction and thus perform a corresponding operation according to the parsed operating instruction. Thus, the computer 20 can be manipulated through the wearable device 10, which can increase the user experience.

A wearable device for operating a computer is further disclosed. The wearable device can be wearable device 20 as discussed in the above embodiment, referring to the above embodiment for details.

A method for operating a computer with a wearable device is further disclosed, and will be described on the basis of the wearable device 10 as disclosed in the first embodiment. Referring now to FIG. 4, the method as disclosed may comprise the following blocks.

At S401, the method includes switching, by the wearable device 10, to a control mode.

At S402, the method includes acquiring, by the wearable device 10, a corresponding operation track of an operation a user performs on the control interface 111.

At S403, the method includes converting, by the wearable device 10, the operation track to an operating instruction and transmitting the operating instruction to the computer 20 to make the computer 20 perform a corresponding operation according to the operating instruction.

At S401, when the user desires to manipulate the computer 20 through the wearable device 10, the wearable device 10 may switch to a control mode, and the display screen 11 of the wearable device 10 may display a control interface 111, an example of which is shown in FIG. 2. In the upper left corner of the control interface 111 may be displayed the connection status and duration between the wearable device 10 and the computer 20, while a Close button may be put on the upper right corner of the control interface 111.

At S402, the wearable device may obtain the operation track by way of a matrix. In particular, the touch screen 11 of the wearable device 10 may beforehand establish a coordinate system X-O-Y, as is shown in FIG. 3. In the figure A denotes the operation the user performs on the control interface 111. The touch screen 11 may acquire the moving coordinates of operation A along a horizontal axis (i.e., X axis) and a vertical axis (i.e., Y axis) respectively, so as to generate a matrix. For example, assume the moving coordinates of operation A along the horizontal axis are 3, 5, 8, while the corresponding moving coordinate values along the vertical axis are 4, 5, 4, then we obtain a matrix

$$[ \begin{matrix}3 & 5 & 8 \\ 4 & 5 & 4\end{matrix} ] .$$

According to the matrix, the touch screen 11 may obtain the operation track of operation A as a single-finger slide.

At S403, the operation track may comprise a single-finger slide, single-finger click, single-finger double-click, single-finger click and hold, double finger slide, and so on. The operating instruction corresponding to the operation track may comprise a mouse movement, mouse left button click to select, mouse left button double-click to select, mouse right button click to select, zooming of a display window on the display screen, and so on.

A wearable device for operating a computer is further disclosed, the wearable device comprising a processor, a memory storage, a transmitter, a bus, and a touch screen. The processor, memory storage, transmitter, and touch screen may be coupled to the bus respectively. The wearable device may enter a control mode, and the touch screen may display a control interface, so when a user performs an operation on the control interface, the touch screen may capture a corresponding operation track by way of a matrix, according to which the touch screen may pre-establish a coordinate system and obtain the moving coordinates of the operation along a horizontal and a vertical axis of the coordinate system respectively, to generate a matrix.

The memory storage may be configured to store a program, and the processor may be configured to execute the program, the program being configured to convert the operation track to an operating instruction.

The transmitter may be configured to transmit the operating instruction to the computer.

The computer may parse the operating instruction and perform a corresponding operation according to the parsed operating instruction.

The operation track may comprise a single-finger slide, single-finger click, single-finger double-click, single-finger click and hold, and double finger slide.

The operating instruction corresponding to the operation track may comprise a mouse movement, mouse left button click to select, mouse left button double-click to select, mouse right button click to select, zooming of a display window on the display screen.

When the wearable device switches to an input mode, the user can enter text on the touch screen, the transmitter may transmit the text to the computer, and the computer may display the text in a text box.

The memory storage as discussed above may comprise a USB flash disk, mobile hard drive, read-only memory (ROM), random access memory (RAM), magnetic disk, optical disk, or any other medium that is able to store program codes. The processor may execute all or part of the blocks of methods illustrated in various embodiments of the disclosure.

To summarize, according to the disclosure the wearable device 10 may acquire a corresponding operation track the user performs on the control interface, and convert the operation track to a corresponding operating instruction and transmit it to the computer 20. The computer 20 may parse the operating instruction and so perform a corresponding operation according to the parsed operating instruction. Thus, the computer 20 can be manipulated through the wearable device 10, increasing the user experience.

The above description involves merely some exemplary embodiments of the disclosure, but is not meant to limit the scope of the disclosure. Any equivalent structure or flow transformations made to the disclosure, or any direct or indirect applications of the disclosure on other related fields shall all be covered within the protection of the disclosure.

1. A wearable device for operating a computer, the wearable device comprising a processor, a memory storage, a transmitter, a bus, and a touch screen, where the processor, the transmitter, the memory storage, and the touch screen are coupled to the bus respectively, wherein the wearable device enters a control mode and the touch screen displays a control interface, when a user performs an operation on the control interface, the touch screen obtains a corresponding operation track by way of a matrix, according to which the touch screen pre-establishes a coordinate system and obtains moving coordinates of the operation along a horizontal and a vertical axis of the coordinate system respectively to generate the matrix;
the memory storage is configured to store a program, and the processor is configured to execute the program, the program being configured to convert the operation track to an operating instruction;
the transmitter is configured to transmit the operating instruction to the computer; and
the computer is configured to parse the operating instruction, and perform a corresponding operation according to the parsed operating instruction;
wherein, the operation track comprises a single-finger slide, single-finger click, single-finger double-click, single-finger click and hold, and double finger slide.

2. The wearable device according to claim 1, wherein the operating instruction corresponding to the operation track comprises a mouse movement, mouse left button click to select, mouse left button double-click to select, mouse right button click to select, and zooming of a display window on the display screen.

3. The wearable device according to claim 2, wherein when the wearable device switches to an input mode, the user enters text on the touch screen, and the transmitter transmits the text to the computer, which displays the text in a text box.

4. A wearable device for operating a computer, the wearable device comprising a touch screen, a first processing module, and a first communication module, where the touch screen and the first communication module are coupled to the first processing module respectively, wherein the wearable device enters a control mode and the touch screen displays a control interface, when a user performs an operation on the control interface, the touch screen obtains a corresponding operation track, the first processing module converts the operation track to an operating instruction and transmits the operating instruction to the computer through the first communication module, and the computer parses the operating instruction and performs a corresponding operation according to the parsed operating instruction.

5. The wearable device according to claim 4, wherein the touch screen obtains the operation track by way of a matrix.

6. The wearable device according to claim 5, wherein the touch screen pre-establishes a coordinate system and obtains moving coordinates of the operation along a horizontal and a vertical axis of the coordinate system to generate a matrix.

7. The wearable device according to claim 4, wherein the operation track comprises a single-finger slide, single-finger click, single-finger double-click, single-finger click and hold, and double finger slide.

8. The wearable device according to claim 7, wherein the operating instruction corresponding to the operation track comprises a mouse movement, mouse left button click to select, mouse left button double-click to select, mouse right button click to select, and zooming of a display window on the display screen.

9. A method for operating a computer with a wearable device, comprising:
switching, by the wearable device, to a control mode;
acquiring, by the wearable device, an operation track of an operation a user performs on a control interface; and
converting, by the wearable device, the operation track to an operating instruction and transmitting the operating instruction to the computer to make the computer perform a corresponding operation according to the operating instruction.

10. The method according to claim 9, wherein acquiring by the wearable device the corresponding operation track of the operation the user performs on the control interface comprises obtaining, by the wearable device, the operation track by way of a matrix.

11. The method according to claim 9, wherein the operation track comprises a single-finger slide, single-finger click, single-finger double-click, single-finger click and hold, and double finger slide.

12. The method according to claim 11, wherein the operating instruction corresponding to the operation track comprises a mouse movement, mouse left button click to select, mouse left button double-click to select, mouse right button click to select, and zooming of a display window on the display screen.

13. The wearable device according to claim 1, comprising a smart watch and smart bracelet.

14. The wearable device according to claim 1, wherein in an upper left corner of the control interface are displayed connection status and duration between the wearable device and the computer, and a Close button used to close the control interface is put on an upper right corner of the control interface.

15. The wearable device according to claim 4, wherein the first communication module is a Bluetooth module.

16. The wearable device according to claim 4, wherein the first communication module is a WiFi module.

17. The wearable device according to claim 4, comprising a smart watch and smart bracelet.

18. The wearable device according to claim 4, wherein in an upper left corner of the control interface are displayed connection status and duration between the wearable device and the computer, and a Close button used to close the control interface is put on an upper right corner of the control interface.

19. The method according to claim 9, further comprising, before the block of switching by the wearable device to the control mode:
pre-installing an application on the computer.

20. The method according to claim 19, wherein the pre-installed application is a text box, the method further comprising:
performing a slide on the wearable device to control a cursor shown on a display screen of the computer to move to an icon of the application;
performing a click on the icon of the application to select and activate the application on the computer to enter a text box;
switching the wearable device to an input mode and entering text on a screen of the wearable device; and
displaying, by the computer, the text in the text box on the display screen of the computer.
